(19) United States
(12) Patent Application Publication
(10) Pub. No.: US 2007/0061189 A1
(43) Pub. Date: Mar. 15, 2007

(54) Method for motivating competitors in an enterprise setting

(75) Inventors: Bryan Rodoni, Livermore, CA (US); Sheree Stewart, Oakland, CA (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/224,652

(22) Filed: Sep. 12, 2005

(51) Int. Cl. G06F 17/30

(52) U.S. Cl. 705/10

(57) ABSTRACT

A computer has computer instructions corresponding to a method for motivating competitors in an enterprise setting. The computer, for example, has computer instructions for providing (102) a number of selectable iconic figures in a customizable graphical user interface (GUI). The computer further has computer instructions for selecting (108) an iconic figure for each of a plurality of competitors in an enterprise setting, establishing (110) one or more competitive metrics for the competitors, monitoring (118) the one or more competitive metrics for each competitor, and updating (120) the iconic figure of each competitor according to changes in their respective one or more competitive metrics.

### FIELD OF THE DISCLOSURE

The present disclosure relates generally to competitive techniques, and more specifically to a method for motivating competitors in an enterprise setting.

### BACKGROUND

Most companies today employ a number of motivation tools to improve employee performance and thereby revenue generation for the enterprise. A common motivator involves a competition between employees in which top performing employees are recognized with cash or other material value rewards if they meet or exceed goals set out by the enterprise. In the midst of the competition, the performance of each employee is usually tracked by common means such as a spreadsheet with interim results distributed by email notifications and/or posted on a bulletin board with, for example, bar charts.

Although the foregoing technique has helped to improve employee performance, it falls short of capitalizing on the human spirit to engage in a more animated and visually stimulating approach to enterprise competition.

A need therefore arises for a method for motivating competitors in an enterprise setting.

### BRIEF DESCRIPTION OF THE DRAWINGS

FIG. 1 depicts a flowchart of a method for motivating competitors in an enterprise setting incorporating teachings of the present disclosure;

FIG. 2 is a snapshot of a graphical user interface (GUI) incorporating teachings of the present disclosure; and

FIG. 3 is a diagrammatic representation of a machine in the form of a computer system within which a set of instructions, when executed, may cause the machine to perform any one or more of the methodologies discussed herein.

### DETAILED DESCRIPTION OF THE DRAWINGS

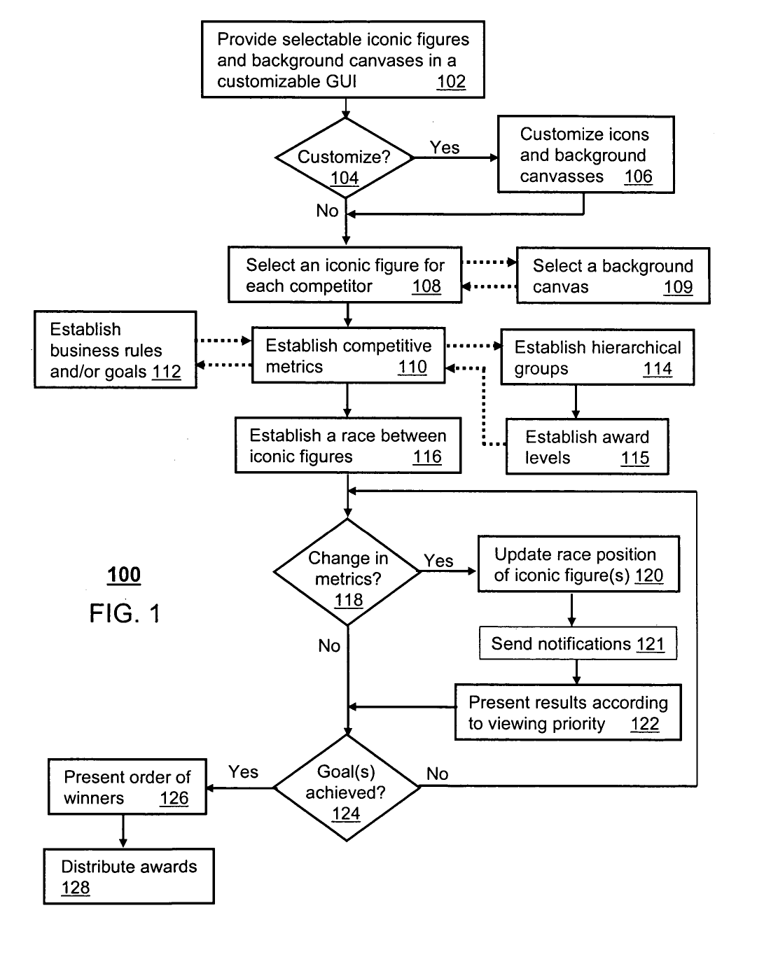

FIG. 1 depicts a flowchart of a method 100 for motivating competitors in an enterprise setting incorporating teachings of the present disclosure. Method 100 operates on a computer system such as a server or desktop computer. Additionally, said system can operate any number of applications. For example, the computer can be programmed with a database management application, and/or a CRM (Customer Relationship Management) application for managing customer accounts, and employee performance. Additionally, software such as game development tools can be utilized for generating background canvases and iconic figures capable of 2D (two-dimensional) or 3D (three-dimensional) animation in a web-based environment. Any of these applications or tools can be utilized by method 100 or integrated therein.

With this in mind, method 100 begins with step 102 where a user of the computer system is presented selectable iconic figures and background canvases in a customization GUI. The iconic figures and background canvases can be created with, for example, the game development tools mentioned above. In step 104, a user who wants an iconic figure or background setting not available in step 102 can choose to proceed to step 106 to develop his or her own iconic figure or background canvas with the aforementioned software tools. In this step, the user can, for example, import new iconic figures, modify existing iconic figures, combine sub-iconic elements to construct new iconic figures, apply animation to existing or new iconic figures, and/or create still or moving background canvases. If customization is not requested, the user can proceed to step 108 thereby selecting an iconic figure for each competitor of the enterprise, and optionally in step 109, a canvas to establish a background setting for the iconic figures.

In step 110, the user then establishes competitive metrics for the competitors. The competitive metrics can be the same for all competitors or tailored uniquely for each competitor. The competitive metrics can be established in step 114 hierarchically so that competitors can compete in accordance with their functional organization, sector, or other divisional strategy used by the enterprise. Additionally, in step 115, award levels can be established according to the temporal order (e.g., 1^{st}, 2^{nd} 3^{rd} place) of the winners.

Step 110 can be further supplemented by step 112 in which business rules and/or goals can be established to assess the competitive metrics. For example, a competitive metric can be represented by a number of referrals made by employees for the purchase of enterprise products or services. A target volume of referrals can represent a goal. A business rule can represent a restriction whereby such referrals cannot include referrals of employees of the enterprise or family members of the employee-competitor.

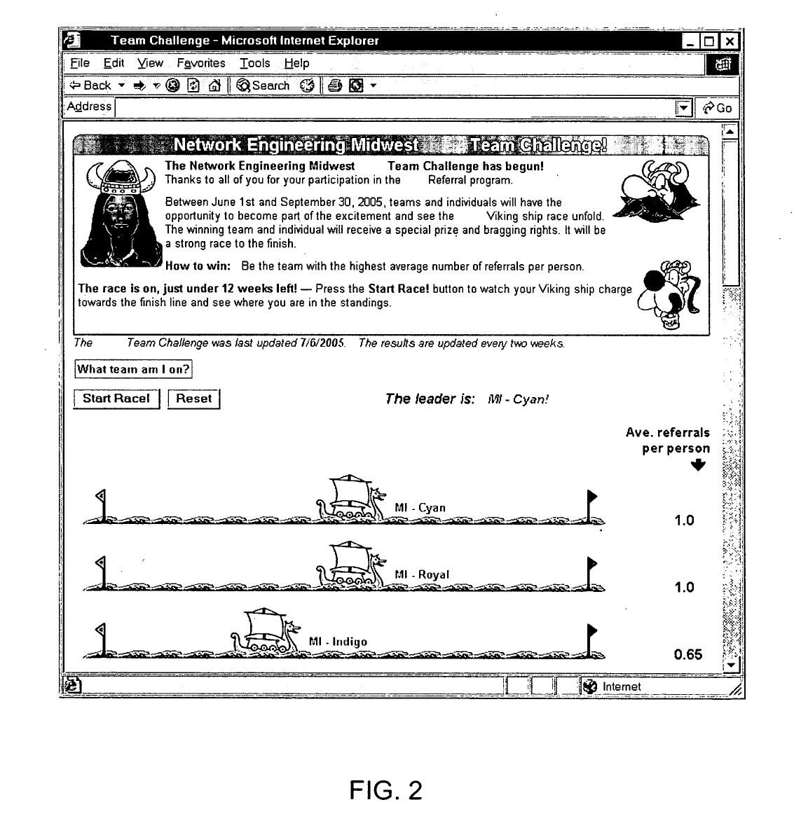

Once the measurement criteria of any one of steps 110, 112, and 114 have been identified, the user can in step 116 establish in the GUI a race between the iconic figures. The race can have any number of graphical representations. For example, a race can be illustrated by an iconic figure that travels from a starting post to a goal post (see FIG. 2). Alternatively, the iconic figure itself can be altered by, for example, a growth pattern. That is, the iconic figure starts small, and when it achieves a particular height, the goal is met. It would be apparent to those of ordinary skill in the art that any graphical representation can be used to establish progress in the race.

Steps 102 through 116 therefore define the process of constructing a GUI-based competition between employees of an enterprise. It would be apparent to an artisan with ordinary skill in the art that any combination of competitive metrics, business rules and/or goals can be applied to method 100 to establish said competitive environment. It would also be apparent to said artisan that any level of sophistication can be applied to the graphics of the GUI. In today's 3D gaming environment, said artisan can envision a 2D or 3D competition that provides a lively and entertaining means to communicate the performance of employees competing amongst each other according to a specific revenue-based enterprise goal or objective.

Steps 118 through 128 of method 100 illustrate an embodiment for executing the competition. Beginning with step 118, the competitive metrics of each competitor is periodically monitored. This step can represent monitoring of a spreadsheet, a CRM, and/or database to track updates relating to the performance of the competitors in accordance with the settings established in steps 110, 112, and 114. If an update of any competitor is detected, then the race position of the iconic figure of the competitor(s) is updated in step 120. To liven up the competitive spirit, a notification can be automatically sent to all or a portion of the competitors in step 121. The notification can be by communication means such as e-mail, or an over-the-air message such as an SMS (Short Message System).

For those who want to view the most recent results, step 122 can present a web-based GUI depending on the viewing priority of the user. This feature can be especially useful in a competition with hierarchical divisions. For instance, an administrator can establish a password-protection environment for competitors that allow them to see only their competition, and not the results of other unrelated divisions of the enterprise. Moreover, the administrator can restrict access so that only upper management can view competitions at higher levels of an enterprise hierarchy.

In step 124, a determination is made whether the goals set out in step 112 have been achieved. If not, the system checks again in step 118 for updates in the competitive metrics. If the goals have been achieved for one or more competitors, then in step 126 a temporal order of the winners is presented. In a competition where there can be three winners (e.g., 1^{st}, 2^{nd} and 3^{rd} place), step 124 can be programmed to announce the winners in step 126 once the slots have been filled or announce winners as they arrive. In either case, awards can be distributed in step 128 to one or more winners according to the award levels established in step 115 (e.g., $1000 for 1^{st} place, $500 for 2^{nd} place, and $100 gift certificate for 3^{rd} place). These awards can be distributed automatically by way of, for example, employee paychecks or checks mailed to the homes of these employees.

FIG. 2 illustrates a snapshot of a GUI incorporating the teachings of method 100. This illustration shows a Viking ship selected as an iconic figure for each competitor. Although FIG. 2 shows the same Viking ships, a unique iconic figure could have alternatively been selected for each competitor. Further illustrated in FIG. 2, is a 2D oceanic background with start and end positions. Similarly here, a more sophisticated background or 3D setting could have been used.

The metric tracked in this illustration is the number of referrals made by the employee-competitor. The more referrals the employees make, the more the ships progress towards the end goal. In this example, a single winner can be defined by the business rules in which case the one who reaches the goal post first wins. The GUI further shows the average number of referrals thus far achieved by each competitor. Notifications of updates to the iconic figures can be submitted to each of the competitors as described above. The notification can be a text message or a snap shot of the latest iconic race position of the competitors with statistical facts appended thereto.

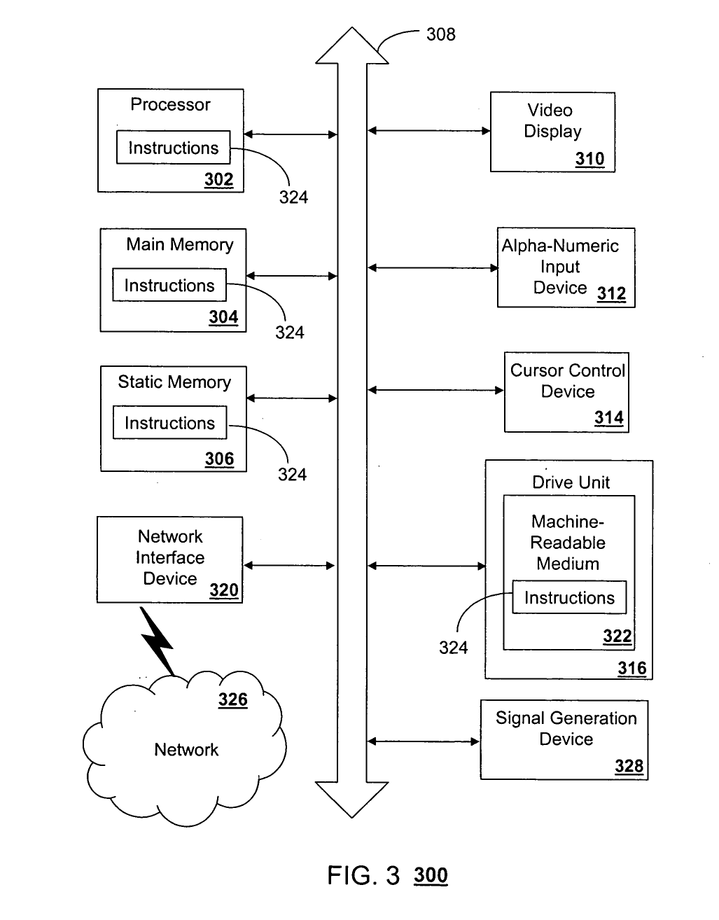

FIG. 3 is a diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated in herein above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium for motivating competitors in an enterprise setting, comprising computer instructions for:
providing a plurality of selectable iconic figures in a customizable graphical user interface (GUI);
selecting an iconic figure for each of a plurality of competitors;
establishing one or more competitive metrics for the plurality of competitors;
monitoring the one or more competitive metrics for each competitor; and
updating the iconic figure of each competitor according to changes in their respective one or more competitive metrics.

2. The storage medium of claim 1, comprising computer instructions for:
establishing in the GUI a race between the iconic figures; and
updating a race position of the iconic figure of each competitor according to changes in their respective one or more competitive metrics.

3. The storage medium of claim 1, comprising computer instructions for notifying one or more competitors of an update to the iconic figure of one or more of the other competitors.

4. The storage medium of claim 3, comprising computer instructions for submitting one among a group of notifications comprising an email, and an over-the-air message for a mobile device.

5. The storage medium of claim 1, comprising computer instructions for monitoring a database for changes in the one or more metrics of each competitor.

6. The storage medium of claim 1, comprising computer instructions for establishing business rules for the one or more competitive metrics.

7. The storage medium of claim 1, comprising computer instructions for:
establishing one or more goals to assess the one or more competitive metrics; and
detecting a sequential order of one or more winners according to the temporal order of competitors achieving the one or more goals.

8. The storage medium of claim 7, comprising computer instructions for:
establishing an award level according to the temporal order of winners;
submitting an award to each of the winners according to their respective award level.

9. The storage medium of claim 1, comprising computer instructions for presenting the GUI of iconic figures according to a most recent update of said iconic figures.

10. The storage medium of claim 1, comprising computer instructions for:
performing at least one among a group of functions comprising importing one or more new iconic figures, modifying one or more existing iconic figures, combining sub-iconic elements to construct one or more iconic figures, applying animation to one or more iconic figures, and creating one among selectable still and moving background canvases to establish a background setting for the iconic figures;
providing selectable background canvases; and
selecting a background canvases to create a background setting for the selected iconic figures.

11. A computer-readable storage medium for motivating competitors in an enterprise setting, comprising computer instructions for:
providing a plurality of selectable iconic figures in a customizable graphical user interface (GUI);
establishing a hierarchy of competitors;
establishing one or more competitive metrics for each level of the hierarchy;
selecting an iconic figure for each competitor;
monitoring the one or more competitive metrics for each competitor; and
updating the iconic figure of each competitor according to changes in their respective one or more competitive metrics.

12. The storage medium of claim 11, comprising computer instructions for:
establishing in the GUI a race between the iconic figures;
updating a race position of the iconic figure of each competitor according to changes in their respective one or more competitive metrics; and
presenting the GUI of iconic figures according to one or more selected levels of the hierarchy.

13. The storage medium of claim 12, comprising computer instructions for limiting access to the GUI of one or more levels of the hierarchy according to a viewing priority of a user.

14. The storage medium of claim 11, comprising computer instructions for:
notifying one or more competitors of an update to the iconic figure of at least one among said competitors and one or more of the other competitors; and
submitting at least one among a group of notifications comprising an email, and an over-the-air message for a mobile device of said update.

15. The storage medium of claim 11, comprising computer instructions for establishing business rules for the one or more competitive metrics.

16. The storage medium of claim 11, comprising computer instructions for:
establishing one or more goals to assess the one or more competitive metrics; and
detecting a sequential order of one or more winners according to the temporal order of competitors achieving the one or more goals at a given level of the hierarchy.

17. The storage medium of claim 16, comprising computer instructions for:
establishing an award level according to the temporal order of winners;
submitting an award to each of the winners according to their respective award level.

18. A method for motivating competitors in an enterprise setting, comprising the steps of:
providing on a web page a plurality of selectable iconic figures in a customizable graphical user interface (GUI);
selecting an iconic figure for each of a plurality of competitors in an enterprise setting;
establishing one or more competitive metrics for the plurality of competitors;
monitoring the one or more competitive metrics for each competitor;
updating the iconic figure of each competitor according to changes in their respective one or more competitive metrics; and
presenting the updated iconic figures on the web page.

19. The method of claim 18, comprising the steps of:
establishing in the GUI a race between the iconic figures;
updating a race position of the iconic figure of each competitor according to changes in their respective one or more competitive metrics; and
presenting the updated race positions on the web page with facts in relation to the race.

20. The method of claim 19, comprising the steps of:
establishing revenue generation goals for the one or more competitive metrics; and
notifying one or more competitors of a race position update of any competitor.
